(19) United States
(12) Patent Application Publication
(10) Pub. No.: US 2011/0309136 A1
(43) Pub. Date: Dec. 22, 2011

(54) System and method for retail store automation

(76) Inventors: Norik Katsakhyan, Dunkirk, MD (US); Ryan Connell Durham, Dunkirk, MD (US)

(21) Appl. No.: 12/803,177

(22) Filed: Jun. 21, 2010

(51) Int. Cl. G06F 17/00; G10H 1/00; G06K 7/01

(52) U.S. Cl. 235/375; 84/600

(57) ABSTRACT

Disclosed herein are systems, methods, and non-transitory computer-readable storage media for playing music at a cash register and for performing price scanning. A method for playing music at a cash register includes, for each item scan, selecting a note from a set of song instructions, and, as feedback for each respective item scan, playing the selected note as part of a sequence to output at least part of a song. A price scanner scans an item in a store, retrieves a price for the item and additional information, and outputs the price for the item and at least one suggestion based on the additional information. A retail store server selects song instructions which can be executed to produce notes of a song, and distributes at least a portion of the song instructions to a cash register for output in response to an item scan.

### BACKGROUND

1. Technical Field

The present disclosure relates to automating retail stores and more specifically to automating aspects of cash registers and price scanners which, in one aspect, involve a retail store server.

2. Introduction

Retail stores are always looking for ways to increase profits by improving the customer experience while simultaneously lowering costs. One way to improve the customer experience is to hire more employees or more skilled, knowledgeable, or dedicated employees, but this approach raises costs. Other approaches make a similar tradeoff. Accordingly, what is needed is improved ways to automate various aspects of the retail experience.

### SUMMARY

Additional features and advantages of the invention will be set forth in the description which follows, and in part will be apparent from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

A first embodiment involves playing music at one or more cash register or other point of sale as items are scanned. For example, as a cashier scans a customer's items, the point of sale device typically beeps or provides some kind of audio indication that the scan was successful. In this embodiment, instead of a single tone, beep, or other standard sound for each scanned item, the beeps can be different tones, volumes, pitches, and so forth. Taken as a whole, the scanning of multiple items can form a song or tune. In one aspect, the point of sale device can play portions of a digitized song.

In one variation, a server in a store with multiple points of sale, including big box retailers such as Wal-Mart, Target, Home Depot, and virtually every supermarket, can coordinate the sounds produced for each scanned item across the multiple points of sale such that the sounds, when combined, form a single song.

A second embodiment is a price scanner which provides enhanced services to customers. The price scanner can be one of multiple price scanners located throughout a retail store floor which allow customers to scan an item and determine its cost before approaching a point of sale to purchase the item. The price scanner can include outputs such as a display, speaker, printer, network connection, wireless connection, and other suitable output modes. The price scanner can include inputs such as a touch screen, barcode scanner, keypad, network connection, microphone, wireless connection, and so forth. The price scanner can accept speech input via the microphone. Braille inputs and outputs can accommodate the blind and visually impaired. The price scanner can retrieve additional information about the item and display at least one suggestion to the customer based on the additional information. For example, the additional information can be a list of related items, and the suggestion can be one of the list of related items. The suggestion can include a map on a display showing where in the store a related item is located. The price scanner can print a coupon or offer some other limited-time personalized promotion for a related item on demand. Price scanners can include significant processing ability or they can be thin clients with only minimal processing ability which rely on a server for processing needs.

In one aspect, the customer can page a retail store employee for assistance with the scanned item or a related item. The price scanner can display audiovisual promotional material about the scanned item or related items. The customer can also indicate a desired quantity of items to purchase and/or arrange for the desired quantity to be ready for pickup at a point of sale. The price scanner can then relay that information to a retail store server which notifies store employees of the request. The price scanner can provide the customer with an expected time of availability for the desired quantity of items and a receipt number or other identifier associated with the desired quantity of items.

A third embodiment is a retail store server. The retail store server can be one or more servers local or remote to a retail store location. For example, each retail location of a chain of stores can include its own server located in a back room, or a single server can serve multiple retail locations. In one aspect, a local server coordinates with a remote server to provide some or all of the services described herein. The retail store server can provide information regarding the types of sounds to produce at each cash register as well as information to the various price scanners.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary computing device;

FIG. 2 illustrates an exemplary retail store technology infrastructure configuration;

FIG. 3 illustrates an exemplary timeline of output across multiple cash registers;

FIGS. 4-8 illustrate exemplary price scanner displays;

FIG. 9 illustrates a first exemplary method embodiment for operating a retail store server in conjunction with cash registers; and

FIG. 10 illustrates a second exemplary method embodiment for operating a retail store server with a price scanner.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The disclosure first discusses an example computing system which can be used to implement all or part of the principles described herein. Next the disclosure turns to a discussion of one specific implementation of a retail store server, followed by a discussion of cash registers and various embodiments of price scanners. Last, the disclosure turns to a discussion of the various exemplary methods. The disclosure now turns to the exemplary computing system.

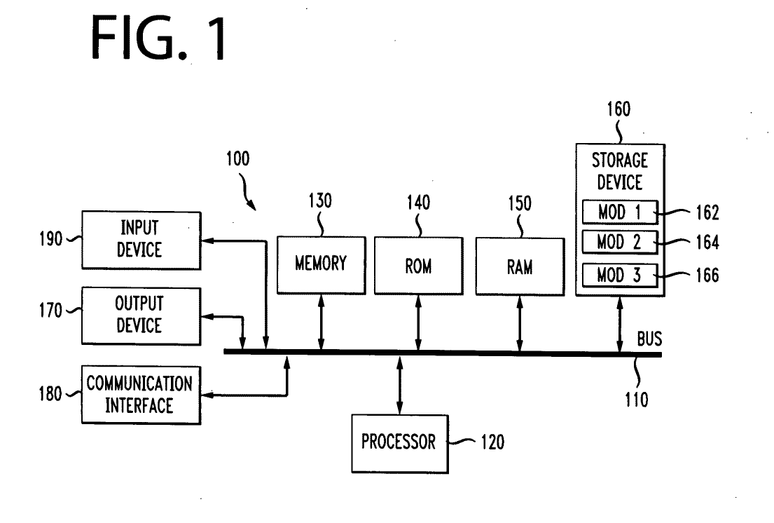

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. These and other modules can be configured to control the processor 120 to perform various actions. Other system memory 130 may be available for use as well. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a tangible and/or intangible computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. The input device 190 may be used by the presenter to indicate the beginning of a speech search query. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Generally speaking, such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

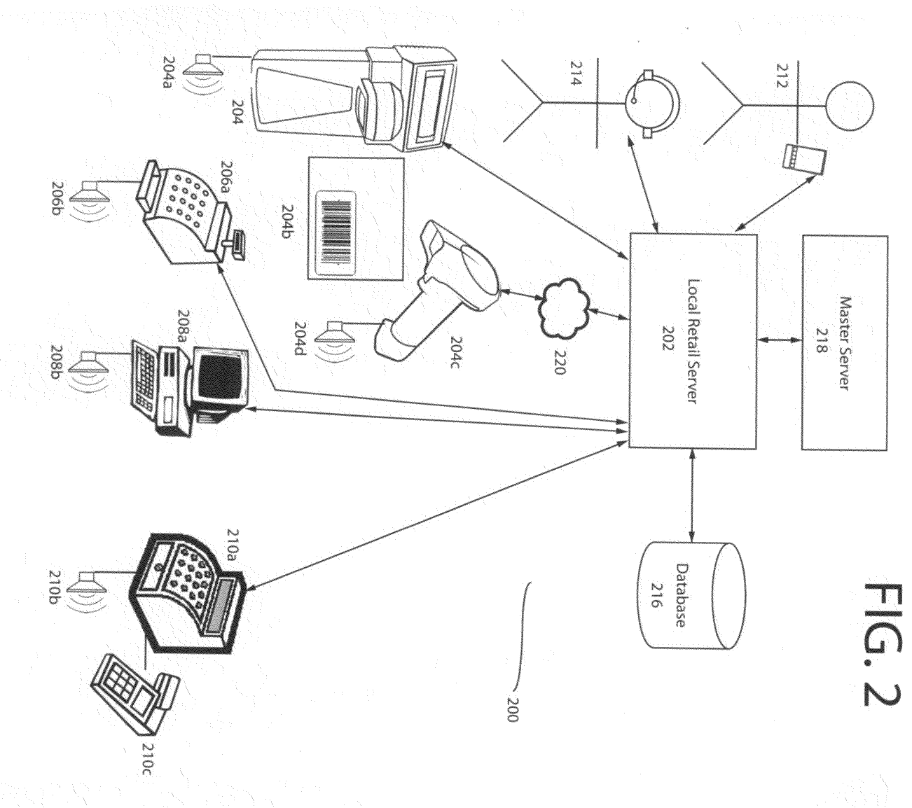

Having disclosed some basic computing device components, the disclosure turns to a discussion of the exemplary retail store technology infrastructure configuration 200 shown in FIG. 2. A local retail store server 202 can communicate with one or more various technology components within and/or without the retail store, such as price scanners 204, point of sale devices 206a, 208a, 210a having audio output devices 206b, 208b, 210b, store employee communication devices 212, 214, a database 216, and a master server 218. The local retail server 202 can coordinate enhanced price scanner 204 abilities, instruct the point of sale devices 206a, 208a, 210a to generate music as items are being scanned, and/or other tasks. The local retail server 202 can be one or more dedicated server and can be combined with other servers to perform multiple tasks. In one aspect, a sufficiently powerful point of sale device can perform all or part of the tasks of the server 202. The disclosure now turns to a discussion of generating music as items are being scanned at points of sale, followed by a discussion of enhanced price scanning abilities.

In one simple embodiment, a single point of sale device 206a stores a sequence of notes, digitized audio, or other audio which, when played back in sequence, forms a song. As an employee or customer scans items for purchase at the point of sale, the point of sale device outputs one of the notes, digitized audio, or other audio clips to acknowledge that the item was scanned properly. The audio outputs can be retrieved from local storage on the point of sale device. The sequence of audio forms a song.

In a first more complex embodiment, the point of sale device 206a accesses a server 202 which provides instructions for generating audio output and/or provides the audio to output. In a second more complex embodiment, the server 202 coordinates audio output of multiple point of sale device 206a, 208a, 210a to produce one song. For example, one set of point of sale devices can produce harmony and another set of point of sale devices can produce melody. In one alternative embodiment where the audio outputs are selected from a digital audio file, as each item is scanned at a point of sale, the server 202 sends a 500 millisecond portion of the digital audio file which is synchronized with the other points of sale such that if an item is scanned at the points of sale at least once every 500 milliseconds, the digital audio file is played back uninterrupted between the collection of points of sale. This can be a motivational tool to promote faster scanning of items at a regular rhythm or interval.

In one aspect, employee interactions as well as customer interactions with the point of sale device can produce audio output. This approach can get the customer involved when they enter their PIN or zip code at a credit card machine 210c, for example, or otherwise interact with point of sale equipment.

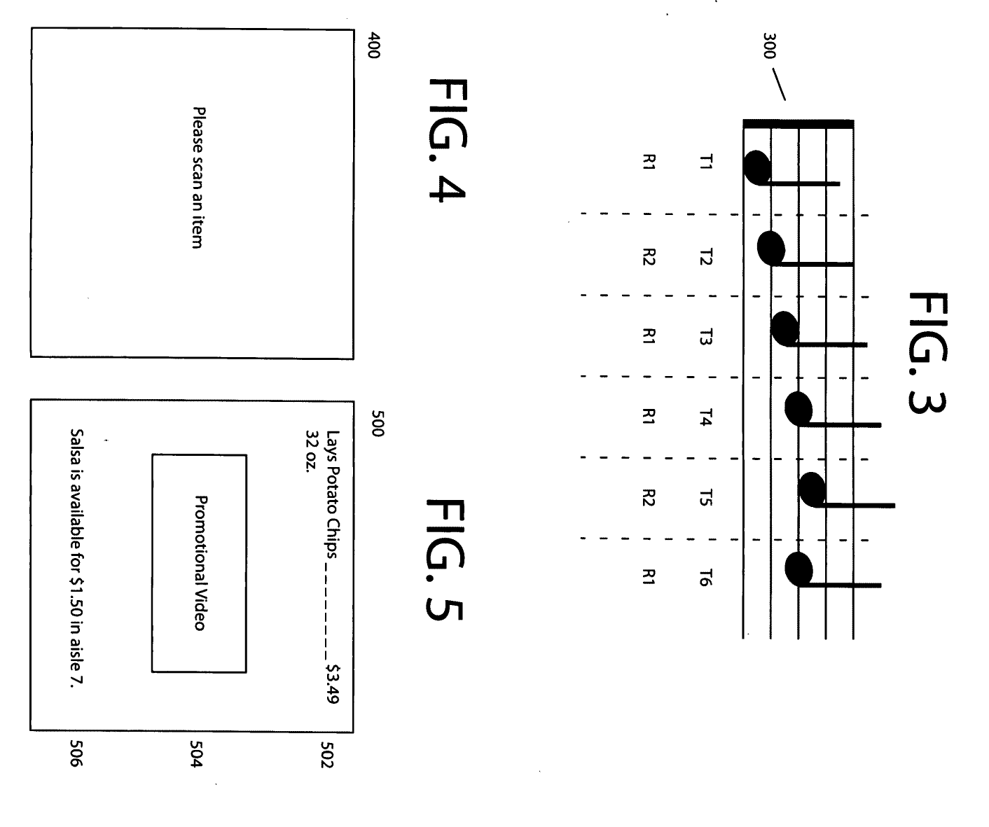

FIG. 3 illustrates an exemplary timeline 300 of output across multiple cash registers. At a first time (T1), an employee at register 1 (R1) scans an item which produces a note at time T1. At time T2, another employee at R2 scans another item which produces a note at time T2. And so on, at time T3, R1 produces a note; at time T4, R1 produces a note; at time T5, R2 produces a note; and at time T6, R1 produces a note. This sequence of notes produces a whole song even though at different times different points of sale produce the notes. A server can provide instructions to the points of sale as each item is scanned or the server can send a periodic signal to the points of sale indicating a synchronization timestamp and a sequence of audio to reproduce based on the timestamp and scanned items.

In another even more complex embodiment, a retail server 202 is aware of and/or controls background music being played in the retail store and coordinates the points of sale to embellish or add accents to the background music through the audio output associated with scanning items. In this way, a basic version of the background music in the retail store can play uninterrupted, and a more complex version of the background music in the retail store is a combination of the basic version and the embellishments associated with scanning items.

In one variation, the various point of sale devices also include a light or other visual indicator which can be activated in conjunction with the audio. This visual indicator can provide another assurance to the person operating the point of sale that the scanning was performed properly. In another variation, when an item was scanned but not recognized or not present in the database 216, the point of sale device can provide some audible feedback other than the portion of the song that would be expected for a correct scan.

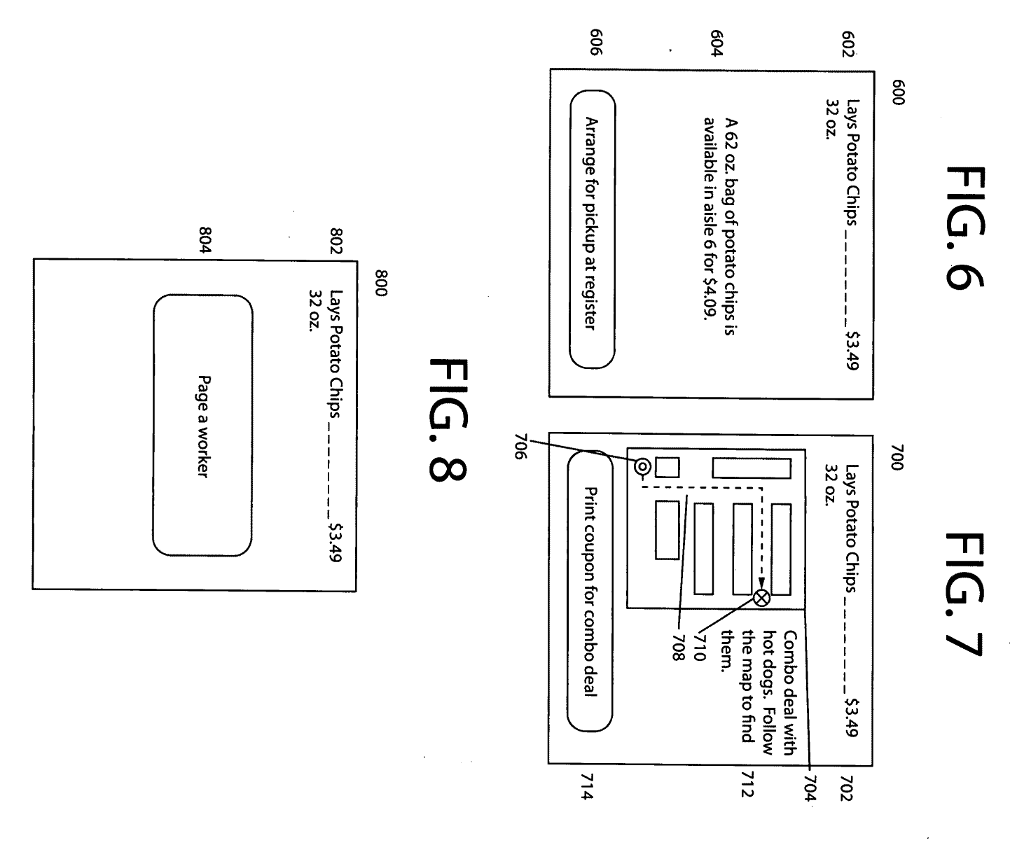

The disclosure now turns to a discussion of enhanced price scanning abilities for price scanners which are separate from a point of sale which accepts payment for items to be purchased. Price scanners are devices which allow customers in a retail environment to determine how much an item costs. A price scanner 204 scans an item 204b with a barcode to convert the barcode into an item identifier and transmits the item identifier to the server 202. The price scanner can include an audio output device 204a. The price scanner can be a stationary unit 204 or a handheld unit 204c with its own audio output device 204d. The connection between the price scanner and the server 202 can be a wired connection or a wireless connection through a wireless network 220. The server 202 queries a database 216 and returns a result to the price scanner 204. The server 202 and the price scanner 204 can communicate wirelessly and/or via a wired connection. However, the server 202 can analyze the scanned item to determine related items in the database 216 which can also be returned to the price scanner. The database 216 can store information such as a list of items for sale in the retail store, description of the items, combo promotions, coupons, suggested companion items, purchase statistics, promotional media (such as images, audio, video), and so forth. FIGS. 4-8 illustrate different enhancements to the display and capabilities of price scanners 204, 204c.

FIG. 4 illustrates an exemplary price scanner display 400 inviting a customer to scan an item. FIG. 5 illustrates an exemplary price scanner display 500 after a customer has scanned a bag of potato chips. The display 500 includes a name and price 502 of the scanned item, a promotional video 504 about salsa, a common companion item purchased with chips, and promotional or advertising text 506 describing the price and location of the salsa in the stores. FIG. 6 illustrates an exemplary price scanner display 600 after a customer has scanned a bag of potato chips. The display 600 includes a name and price 602 of the scanned item, and a related item 604 that is a larger, more economical version of the scanned items, for example. In some variations, the related item is another brand, such as a store brand, or a substitute item that is similar, such as powdered egg whites as a substitute for egg whites. The display 600 can also include a button or other input where a user can arrange for pickup 606 at the register or other point of sale. FIG. 7 illustrates a display 700 after a customer has scanned a bag of potato chips. The display 700 includes a name and price 702 of the scanned item, and an available combo deal 712 with hot dogs. The display 700 can include an interface 714 for a user to print a coupon at the price scanner. In addition, the display 700 can include a map 704 showing a path 708 to navigate in the retail store from the price scanner 706 to the hot dogs 708. If the user prints the coupon, the coupon can include a paper version of the map and/or a picture of the hot dog packaging for easy identification. The price scanner can print just a map without a coupon. In yet another embodiment, FIG. 8 illustrates a display 800 after a customer has scanned a bag of potato chips. The display 800 includes a name and price 802 of the scanned item. The display 800 can also include a button 804 to page a worker or employee for assistance with the scanned item. In some cases, the page a worker button can include a reason code, such as “pricing question”, “item details question”, or “other question”. Any of these embodiments can be combined in whole or in part with each other.

The exemplary displays shown in FIGS. 4-8 can be embodied in a stationary price scanner not part of a point of sale. For example, retail stores often have similar limited-ability price scanners positioned throughout their retail floor. However, the exemplary displays can also be incorporated into mobile price scanners which customers carry with them throughout the store. While customers can carry the mobile price scanners throughout the store and scan items as they are added to a cart, the mobile price scanners are different from a point of sale, inasmuch as the price scanners do not accept payment for the scanned items.

A stationary price scanner can include a basket attached or nearby for customers who scan an item and decide that they do not want to purchase the scanned item. The customer can deposit the unwanted item into the basket, similar receptacle, or location. The basket can include a sensor, such as a scale or a camera, that identifies when the customer deposits an unwanted item into the basket and which item was deposited. Because the item was just scanned, the price scanner is aware of the item type and where it belongs in the store. The price scanner can track how many items come from each area of the store. As the basket fills up, the price scanner can send a notification to one or more employees to collect and reshelf items in the baskets. The notification can be sent to employees telling them which items and/or how many items to pick up from which baskets. Further, a designated ‘collector’ can collect items from baskets for his own and neighboring areas in the store. An example best illustrates this.

In this example, user 1 at scanner 1 scans a can of beans, a DVD, and a book, decides she does not want these items and deposits them in basket 1. User 2 at scanner 2 scans a CD and deposits it in basket 2. User 3 at scanner 3 scans a box of noodles and a magazine and deposits them in basket 3. On a periodic basis, when the number of items reaches a threshold, when a specific category of items reaches a threshold, or based on some other triggering event. At such a triggering event, any of the price scanners and/or the server can send one or more notifications to employees in the various areas of the store. For instance, the system can send a notification wirelessly to a worker's earpiece in the food area to collect and reshelf one item from basket 1 and one item from basket 3. The notification can include the type of item to pick up as well, such as a can of beans and a box of noodles. The system can send a notification to a manager computer in the media area of the store to pick up a DVD, CD, book, and magazine from baskets 1, 2, and 3. The manager sees the notification on the computer and can then make a judgment how, when, and who to send to collect and reshelf the items from the baskets.

Especially for, but not limited to, frozen or refrigerated items such as ice cream, eggs, or raw meat which are easily spoilable, the price scanner can send an urgent notification to the appropriate employee to collect and reshelf spoilable items deposited into the basket. The urgent notification can be sent to multiple employees to more quickly collect the item.

This approach is advantageous because customers typically scan items and leave undesired items somewhere near the price scanner. This leads to cluttered items which must be cleaned up by store employees. This approach simplifies and streamlines the cleaning up of such scanned items. Employees do not need to check baskets without knowing that something is there to pick up. Further the basket is an improvement in and of itself because without the basket, customers just place the unwanted scanned items anywhere in the store, which is difficult to clean up after.

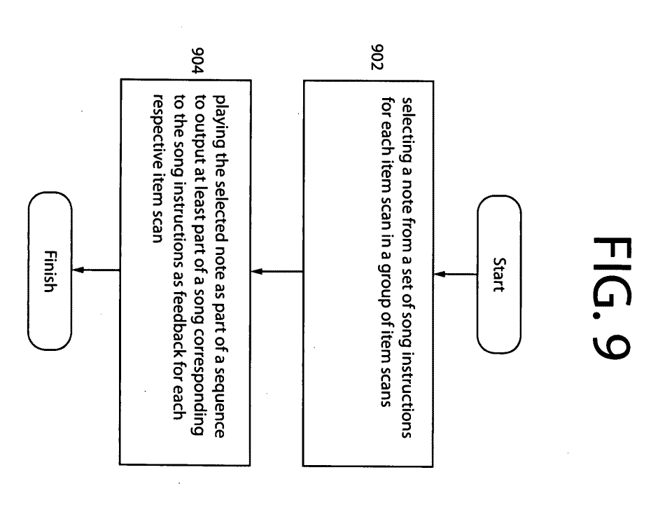

The disclosure now turns to the exemplary method embodiments. FIG. 9 illustrates a first exemplary method embodiment for operating a retail store server in conjunction with cash registers. The method can play music at one or more cash register. The method is discussed in terms of a system 100, as shown in FIG. 1, configured to practice the method. The system 100 selects a note from a set of song instructions for each item scan in a group of item scans (902). In one embodiment, song instructions can include a set of individual tones for a set of point of sale devices. For example, the server can assign a first note to a first point of sale device, a second note to a second point of sale device, a third note to a third point of sale device, and so forth. As the point of sale devices scan items, each device outputs its own note. The server can change the notes assigned to the various point of sale devices periodically. However, in this variation, each point of sale device plays sounds of a single note until the server instructs otherwise. The server can record and/or save a combination of the sequence of audio outputs from different point of sale devices.

The song instructions can be associated with a customer, an employee, a retail location, a franchise, a corporate entity, day, time, holiday, and/or season. As another example, a particular customer's favorite song can be used when that customer checks out at a point of sale. An employee working as a cashier can select the song to be generated. Point of sale devices at different retail locations can generate different songs. Different seasons and holidays can lead to different types of music, such as spooky music, patriotic music, or Christmas music at the appropriate times of year.

The system 100 plays the selected note as part of a sequence to output at least part of a song corresponding to the song instructions as feedback for each respective item scan (904). The system 100 can then select the note from the set of song instructions stored on a server. The cash register can play a subset of the song instructions in concert with other cash registers under direction of the server such that the cash register and the other cash registers play notes which, when combined, form one song.

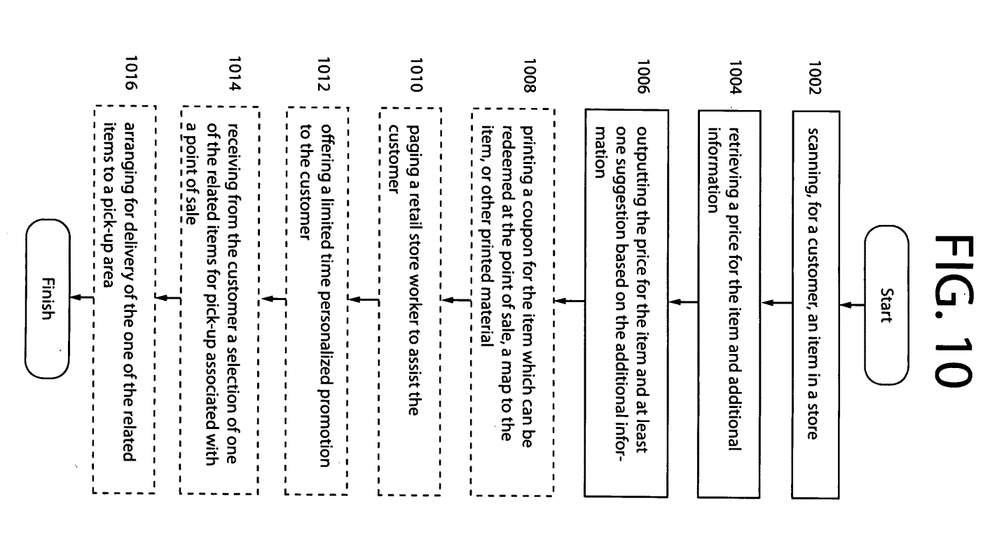

FIG. 10 illustrates a second exemplary method embodiment for operating a retail store server with a price scanner. This method is also discussed in terms of a system 100 configured to practice the method. The system 100 scans, for a customer, an item in a store (1002). In one variation, the system 100 scans the item not at a point of sale. The price scanner can be a mobile device which customers carry around the retail store or the price scanner can be at a fixed location in the store.

The system 100 retrieves a price for the item and additional information (1004). The additional information can include a list of related items and the suggestion can include at least one of the list of related items. The additional information can include a location of a related item in the store, in which case, the system 100 can further display a map with directions from the price scanner to the location of the related item. The additional information can further include audiovisual material, such as a promotional image, an advertisement video clip, or an audio clip.

The system 100 outputs the price for the item and at least one suggestion based on the additional information (1006). The suggestion can be for a different item, a larger version of the item, another item commonly purchased with the item, coupons for the item, other promotional offers, and so forth.

The system 100 can optionally print a coupon for the item which can be redeemed at the point of sale, a map to the item, or other printed material (1008). The price scanner can include an integrated printer or the printer can be a separate unit. In one option, the printer is not a physical printer, but a virtual printer that generates an electronic ‘printed’ image and emails the image to a smartphone or other portable device which the customer can use as a map to navigate the store or as a scannable coupon at a point of sale.

The system 100 can optionally page a retail store worker to assist the customer (1010), offer a limited time personalized promotion to the customer (1012), and/or receive from the customer a selection of one of the related items for pick-up associated with a point of sale (1014) and arrange for delivery of the one of the related items to a pick-up area (1016). The system 100 can page a retail store worker via radio and the customer can communicate with the worker via a microphone and speaker in the price scanner. Alternatively, the system 100 can page a retail store worker by sending a text message or sending another alert to a worker, manager, or central notification area. The selection can include a quantity of items. For example, if the customer scans a package of hot dogs and the suggested is hot dog buns, the user can indicate a quantity of hot dog buns, such as 5 packages, to arrange for delivery to a pick-up area. The pick-up area can be a separate area from the point of sale, can be near the point of sale, or can be one or more designated points of sale. For example, the price scanner can indicate that the hot dog buns will be waiting at cash register #12 within the next 10 minutes. In this case, the price scanner can also print out a ticket with a number on it which the customer tenders to claim the delivered items at the designated pickup area.

In one embodiment, the retail store server includes a first module configured to control or controlling the processor to select a set of song instructions from a group of sets of song instructions, in which each set of song instructions can be executed to produce notes of a song, and a second module configured to control or controlling the processor to distribute at least a portion of the set of song instructions to a cash register for output in response to an item scan at the cash register. The instructions can include instructions for outputting or adjusting output audio based on at least one of tone, volume, duration, timbre, and timing. The instructions can include portions of digitized audio and/or references to portions of digitized audio. The song instructions can be associated with at least one of a customer, an employee, a retail location, a franchise, a corporate entity, day, time, holiday, and season.

Any or all of the embodiments described herein can be implemented in numerous combinations. Existing retail automation approaches can also be combined with the approaches, techniques, and details disclosed herein.

Embodiments within the scope of the present disclosure may also include tangible and/or non-transitory computer-readable storage media for carrying or having computer-executable instructions or data structures stored thereon. Such computer-readable storage media can be any available media that can be accessed by a general purpose or special purpose computer, including the functional design of any special purpose processor as discussed above. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles disclosed herein may be applied to film production and editing pedagogy. Those skilled in the art will readily recognize various modifications and changes that may be made to the principles described herein without following the example embodiments and applications illustrated and described herein, and without departing from the spirit and scope of the disclosure.

We claim:

1. A method for playing music at a cash register, the method comprising:
for each item scan in a plurality of item scans, selecting a note from a set of song instructions; and
as feedback for each respective item scan, playing the selected note as part of a sequence to output at least part of a song corresponding to the song instructions.

2. The method of claim 1, further comprising selecting the note from the set of song instructions stored on a server.

3. The method of claim 2, wherein the cash register plays a subset of the song instructions in concert with other cash registers under direction of the server such that the cash register and the other cash registers play notes which, when combined, form one song.

4. The method of claim 1, wherein the song instructions are associated with at least one of a customer, an employee, a retail location, a franchise, a corporate entity, day, time, holiday, and season.

5. A price scanner comprising:
a processor;
a first module controlling the processor to scan, for a customer, an item in a store;
a second module controlling the processor to retrieve a price for the item and additional information; and
a third module controlling the processor to output the price for the item and at least one suggestion based on the additional information.

6. The price scanner of claim 5, wherein the additional information comprises a list of related items, and wherein the at least one suggestion comprises at least one of the list of related items.

7. The price scanner of claim 6, wherein the additional information comprises a location of the related items within the store.

8. The price scanner of claim 7, wherein the third module further controls the processor to display a map with directions from the price scanner to the location of at least one related item.

9. The price scanner of claim 5, further comprising a fourth module controlling the processor to print a coupon for the item which can be redeemed at the point of sale.

10. The price scanner of claim 5, further comprising a fourth module controlling the processor to page a retail store worker to assist the customer.

11. The price scanner of claim 5, wherein the price scanner is not at a point of sale.

12. The price scanner of claim 5, further comprising a fourth module controlling the processor to offer a limited time personalized promotion to the customer.

13. The price scanner of claim 5, further comprising:
a fourth module controlling the processor to receive from the customer a selection of one of the related items for pick-up associated with a point of sale; and
a fifth module controlling the processor to arrange for delivery of the one of the related items to a pick-up area.

14. The price scanner of claim 13, wherein the selection comprises a quantity.

15. The price scanner of claim 5, wherein the additional information comprises audiovisual promotional material.

16. The price scanner of claim 5, wherein the price scanner is one of a mobile device and a fixed-location device in the store.

17. A retail store server comprising:
a processor;
a first module controlling the processor to select a set of song instructions from a plurality of sets of song instructions, wherein each set of song instructions can be executed to produce notes of a song; and
a second module controlling the processor to distribute at least a portion of the set of song instructions to a cash register for output in response to an item scan at the cash register.

18. The retail store server of claim 17, wherein the instructions comprise instructions for at least one of tone, volume, duration, timbre, and timing.

19. The retail store server of claim 17, wherein the instructions comprise at least one of portions of digitized audio and references to portions of digitized audio.

20. The retail store server of claim 17, wherein the song instructions are associated with at least one of a customer, an employee, a retail location, a franchise, a corporate entity, day, time, holiday, and season.
